(19) United States
(12) Patent Application Publication
(10) Pub. No.: US 2025/0346065 A1
(43) Pub. Date: Nov. 13, 2025

(54) Silicone Scraper Accessory For A Paint Brush

(71) Applicant: Jonah Gillego, Sunland, CA (US)

(72) Inventor: Jonah Gillego, Sunland, CA (US)

(21) Appl. No.: 18/658,974

(22) Filed: May 8, 2024

(51) Int. Cl. B44D 3/16; A46B 15/00

(52) U.S. Cl. CPC B44D 3/164; A46B 15/0081; A46B 2200/202

(57) ABSTRACT

The invention of the present subject matter relates to a silicone scraper accessory which is detachably secured to the tip end of a paint brush handle. The silicone scraper accessory is formed as a one-piece molded silicone element having a narrow opening which is designed to be pushed onto and tightly engage the tip end of a paint brush. The silicone scraper accessory is ideal for removing painting imperfections from wet-painted surfaces, for removing wet paint from surfaces, and for use with other wet applications and delicate surfaces.

### FIELD OF INVENTION

The present invention relates a silicone scraper accessory having a silicone blade edge which is designed specifically to be inserted and detachably secured over the tip end of the handle of a paint brush. Preferably, the silicone scraper is molded in the form of a one-piece element.

### BACKGROUND OF THE INVENTION

For any painter, whether professional or amateur, the art of painting a wall can provide certain challenges. For example, the paint can pick up particles and leave tiny clumps on the painted surface. The particles can be from dust on the drywall, fiber from the paint roller or other airborne particles. Typically, the painter uses a finger to wipe and remove these tiny clumps but of course this action not only results in wet paint on the hands but also can be a frustrating process. Other solutions to this problem have been to use a cloth rag to wipe of the paint impurities but as with the use of the finger, this results in a messy rag with wet paint thereon.

### PRIOR ART

The prior art has attempted to provide scraper elements associated with paint brushes. For example, U.S. Patent Application 2008/0992313 A1 to Griffin discloses a metal scraper wedge that fits onto the tip of a paint brush. However, this metal scraper wedge is designed specifically for use on solid dried paint that needs to be removed or for putty that needs to be applied. It is not designed for use with wet paint during the painting process. In U.S. Pat. No. 10,709,232 to Sagastume, a paint brush is disclosed having a rotatable rigid scraper blade attached at the tip of the brush handle. Again, the blade described by Sagastume is not for use on wet paint but rather on a surface that requires scraping prior to painting. In addition, the scraper blade is not quickly and easily detachably secured to the tip of the paint brush. U.S. Patent 2015-0026986 to Berglun discloses a standard paint scraper with a blade element and a scraping edge for preparing a wall for painting. Despite the efforts of the prior art, a need still exists for a soft and malleable scraper element which can quickly remove wet paint and imperfections from delicate surfaces.

### SUMMARY OF THE INVENTION

The invention of the present subject matter relates to a silicone scraper accessory having a silicone blade edge which is designed specifically to be inserted and detachably secured over the tip end of the handle of a paint brush.

Accordingly, it is an object of the present subject matter to provide a silicone scraper accessory having a silicone blade edge which is detachably secured to the tip end of the handle.

It is another object of the present subject matter to provide a silicone scraper accessory for a paint brush having a silicone blade edge which is detachably secured to the tip end of the handle of a paint brush, wherein the silicone scraper accessory is in the form of a one-piece molded silicone element which is soft and malleable.

It is a further object of the present subject matter to provide a silicone scraper accessory which is detachably secured to the tip end of the handle of a paint brush, wherein the silicone scraper element can be used on wet-painted surfaces to remove imperfections in the wet paint.

It is an additional object of the present subject matter to provide a silicone scraper accessory which is detachably secured to the tip end of the handle of a paint brush, wherein the scraper element can remove tiny clumps of particles within the wet-painted surface.

It is still another object of the present subject matter to provide a silicone scraper accessory which is detachably secured to the tip end of the handle of a paint brush, wherein the silicone scraper accessory can be used to squeegee all the paint out of a paint can.

It is a yet another object of the present subject matter to provide a silicone scraper accessory which is detachably secured to the tip end of the handle of a paint brush, wherein the silicone scraper accessory can be used to wipe wet paint off the side of a can and from the paint can rim after pouring paint onto a paint tray.

It is an additional object of the present subject matter to provide a silicone scraper accessory which is detachably secured to the tip end of the handle of a paint brush, wherein the silicone scraper accessory can be used to squeegee wet paint from the paint tray.

It is a further of the present subject matter to provide a silicone scraper accessory which is detachably secured to the tip end of the handle of a paint brush, wherein the silicone scraper blade edge can be used on other wet applications and delicate surfaces.

These and other objects of the present subject matter are accomplished by providing a one-piece silicone molded scraper accessory having a particular design shape for easily and quickly being detachably secured to the tip end of a typical paint brush handle.

### BRIEF DESCRIPTION OF DRAWINGS

FIG. 1 is a perspective view of the present subject matter illustrating the manner in which the silicon scraper accessory is to be detachably secured to the tip end of the handle.

FIG. 2 is a perspective view of the silicone scraper accessory of the present subject matter detachably secured to the tip end of a paint brush.

FIG. 3 is a side perspective view of the silicone scraper accessory of the present subject matter showing the narrow opening which engages the tip end of the handle of a paint brush.

FIG. 4 is a schematic view of the silicone molded scraper of the present subject matter.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

The present subject matter is directed to a silicone scraper accessory in the form of a one-piece molded silicone element having a silicone blade edge which specifically is designed to be inserted over the tip of the paint brush handle and be detachably secured thereto. The scraper accessory is composed of silicone for a very simple reason. Wet paint does not stick to silicone. Thus, wiping wet paint from a surface or removing tiny clumps from a still wet painted surface provides an easy and efficient method to paint and remove imperfections in the painting process. And, having the silicone scraper accessory detachably secured to the tip of the paint brush handles enables the painter to simply flip the paint brush in his/her hand to remove the imperfection in the painting process and then flip the paint brush back to the painting position to continue painting.

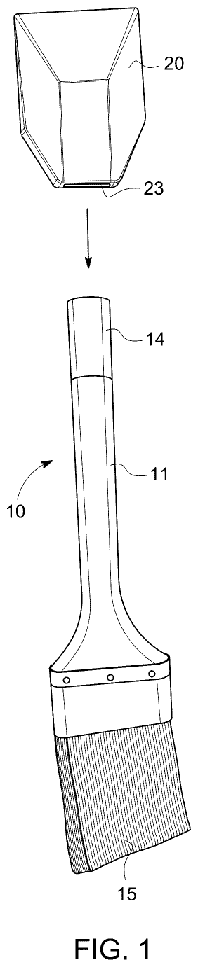

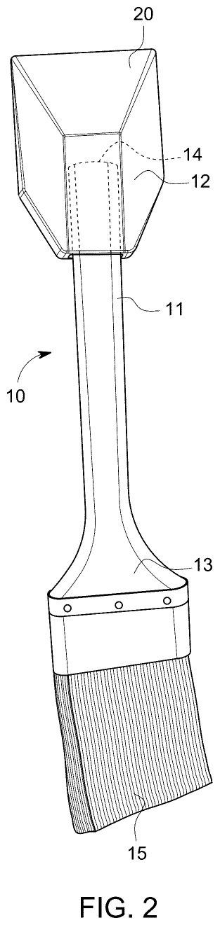

Referring to FIG. 1 and FIG. 2 a paint brush 10 is shown having an elongated handle 11 with a proximal end 12 and a distal end 13, the proximal end of the handle having a tip 14, the distal end of the elongated handle terminating into a plurality of brush bristles 15. As shown in FIG. 1, a silicone scraper accessory 20 having a narrow opening 23 which is designed to be pushed onto the tip 14 at the proximal end 12 of the paint brush handle 11 and be detachably secured thereto. FIG. 2 shows the silicone scraper accessory 20 detachably secured to the tip 14 of the paint brush 10.

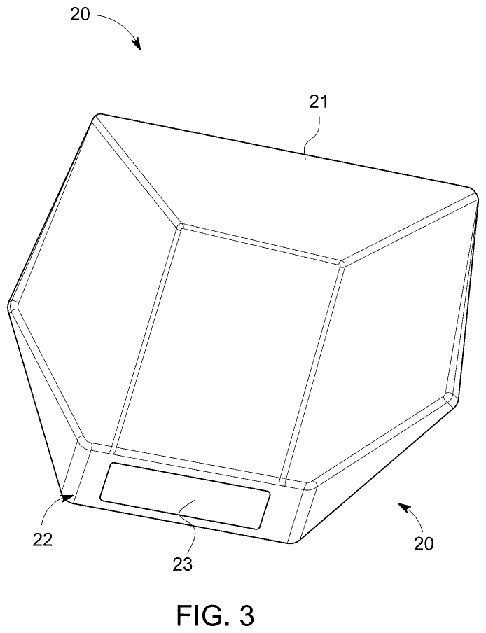

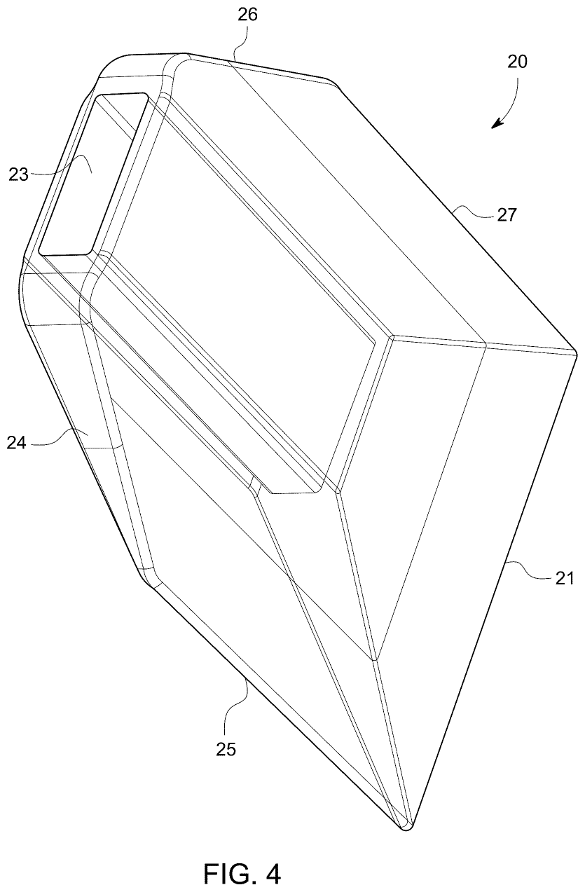

Referring now to FIG. 3 and FIG. 4, the silicone scraper accessory 20 is molded as a one-piece silicone element having a first end 21 which narrows to form a scraper blade edge, a second end 22 distal to the first edge, the second end having a narrow opening 23 which is specifically designed to engage the tip 14 of the paint brush handle 11. Because the scraper accessory 20 is composed of silicone which is soft and malleable, the narrow opening 23 can be adapted to be of sufficient flexibility and size to tightly engage the tip 14 simply by pushing the tip 14 into the narrow opening 23. In this manner the silicone scraper accessory can be quickly and easily detachably secured to the proximal end 12 of the handle 11 of paint brush 10.

FIG. 4 illustrates a preferred embodiment of the silicone molded scraper 20 of the present subject matter. In particular, the silicone scraper accessory 20 has tapered side edges 24 and 26 which extend outwardly from the second end 22 and then downwardly forming edges 25 and 27 respectively and terminate into the scraper blade edge at first end 21.

At any time during the painting process, the painter can quickly and easily remove the one-piece silicone scraper accessory 20 from the tip 14 of the paint brush handle 11 and rinse the silicone scraper accessory with water. As wet paint does not stick or adhere to silicone, cleaning the scraper is effortless, thereby facilitating the cleaning up process. The addition of the silicone scraper accessory 20 also provides a more enhanced balance to the paint brush.

It is contemplated to within the scope of this present subject matter that the one-piece silicone molded scraper and be manufactured in different sizes to accommodate paint brushes having elongated handles of varying diameters. For example, a small version of the one-piece silicone molded scraper can be designed for use on standard art brushed. The use of the silicone molded scraper on art brushes will not only facilitate the artist in removing tiny clumps of paint particles, but will replace the use of an artist's metal scraper which can cut into the painting canvas thereby ruining the artist's work.

It will be understood by those skilled in the art of painting that the silicone scraper accessory of the present subject matter can be used for any wet applications and delicate surfaces. It also can be used to facilitate the application of painter's caulk. It is very common for a painter to encounter fissures in a wall surface or a hairline crack which may have been missed during the original prepping of the surface or may have occurred after the original prepping. Using the blade edge of the silicone scraper accessory, painter's caulk can be spread easily and efficiently over the fissure or hairline crack in the wall surface without having to use the typical drywall taping knife.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A silicone scraper accessory for a paint brush, said silicone scraper accessory comprising a first end which narrows to form a scraper blade edge, a second end distal to said first end, said second end having a narrow opening adapted to tightly engage the tip end of a handle of said paint brush and be detachably secured to said tip end of said paint brush.

2. The silicone scraper accessory for a paint brush in accordance with claim 1, further comprising two tapered side edges which extend downwardly from said second end and then downwardly to form two secondary edges which terminate into said scraper blade edge.

3. The silicone scraper accessory in accordance with claim 1, wherein said silicone scraper accessory is formed as a one-piece molded silicone element which is soft and malleable.

4. The silicone scraper accessory in accordance with claim 3, wherein said narrow opening is adapted to be of sufficient flexibility and size to tightly engage said tip end of said paint brush by pushing said tip end into said narrow opening, whereby said silicone scraper accessory is detachably secured to said tip end of said paint brush.

5. The silicone scraper accessory in accordance with claim 2, wherein said silicone scraper accessory is formed as a one-piece molded silicone element which is soft and malleable.

6. The silicone scraper accessory in accordance with claim 5, wherein said narrow opening is adapted to be of sufficient flexibility and size to tightly engage said tip end of said paint brush by pushing said tip end into said narrow opening, whereby said silicone scraper accessory is detachably secured to said tip end of said paint brush.

7. A silicone scraper accessory detachably secured to a paint brush, wherein said silicone scraper accessory comprising a first end which narrows to form a scraper blade edge, a second end distal to said first end, said second end having a narrow opening, and wherein said paint brush comprises an elongated handle having tip end which is distal from a brush end of said paint brush, said narrow opening adapted to tightly engage said tip end of said elongated handle of said paint brush.

8. The silicone scraper accessory in accordance with claim 7, wherein said silicone scraper accessory is formed as a one-piece molded silicone element which is soft and malleable.

9. The silicone scraper accessory in accordance with claim 8, wherein said narrow opening is adapted to be of sufficient flexibility and size to tightly engage said tip end of said paint brush by pushing said tip end into said narrow opening, whereby said silicone scraper accessory is detachably secured to said tip end of said paint brush.

10. The silicone scraper accessory in accordance with claim 9, further comprising two tapered side edges which extend outwardly from said second end and then downwardly to form two secondary edges which terminate into said scraper blade edge.

11. The silicone scraper assembly in accordance with claim 1, wherein said silicone scraper accessory can be manufactured in different sizes to accommodate paint brush handles of varying diameters.

12. The silicone scraper assembly in accordance with claim 11, wherein said silicone scraper accessory is of sufficient size to be used on an artist paint brush.

13. The silicone scraper assembly in accordance with claim 7, wherein said silicone scraper accessory can be manufactured in different sizes to accommodate paint brush handles of varying diameters.

14. The silicone scraper assembly in accordance with claim 13, wherein said silicone scraper accessory is of sufficient size to be used on an artist paint brush.
